(19) United States
(12) Patent Application Publication
(10) Pub. No.: US 2026/0322055 A1
(43) Pub. Date: Oct. 15, 2026

(54) REMOVAL ADAPTER AND CONNECTOR ASSEMBLY

(71) Applicant: Japan Aviation Electronics Industry, Limited, Tokyo (JP)

(72) Inventor: Masaki ISHIGURO, Tokyo (JP)

(21) Appl. No.: 19/421,745

(22) Filed: Dec. 16, 2025

(30) Foreign Application Priority Data
Apr. 14, 2025 (JP) 2025-066139

(51) Int. Cl. H01R 43/26; H01R 13/512

(52) U.S. Cl. CPC H01R 43/26; H01R 13/512

(57) ABSTRACT

A removal adapter includes a base member fixed to an electronic device, a cover member disposed to contact the base member in a fitting direction and having first through holes in which first connectors are inserted, a cover member moving mechanism having a set screw screwed and held in a screw hole formed in one of the base member and the cover member, and a fall-off preventing portion preventing the set screw from falling off the screw hole in a state where the cover member is in contact with the base member, each of the first through holes having a dimension smaller than that of a widest portion of each of the first connectors, and when the cover member is moved using the cover member moving mechanism, the first connectors are moved together with the cover member in the fitting direction and removed from second connectors.

### BACKGROUND OF THE INVENTION

The present invention relates to a removal adapter, particularly to a removal adapter used to collectively remove a plurality of first connectors fitted with a plurality of second connectors attached to an electronic device, from the plurality of second connectors.

The present invention also relates to a connector assembly including the removal adapter.

For example, JP H05-251133 A discloses a multi-connector that collectively attaches or detaches a plurality of coaxial connectors as shown in FIG. 52. In this multi-connector, a plurality of coaxial connectors 2 attached to the distal ends of a plurality of coaxial cables 1 are collectively retained in an inner holder 3, and an outer holder 4 is disposed to cover the inner holder 3 from the opposite sides to be slidable with respect to the inner holder 3 in a connection direction of the coaxial cables 1.

By moving the inner holder 3 relatively to a housing 6 fixed to a backplane 5 of an electronic device, the coaxial connectors 2 are collectively inserted into the housing 6, so that the coaxial cables 1 are each connected to the electronic device.

The housing 6 is provided in its inside with a claw portion 6A at a position corresponding to a small diameter portion 2A of each coaxial connector 2 as shown in FIG. 53, and even when the coaxial connector 2 is tried to be pulled out from the housing 6, the claw portion 6A catches on a large diameter portion 2B of the coaxial connector 2, thereby preventing the coaxial connector 2 from being pulled out. Thus, the connection of the coaxial cables 1 with respect to the electronic device is maintained.

When the outer holder 4 is moved relatively to the inner holder 3 toward the housing 6 from the state where the coaxial cables 1 are connected to the electronic device, the distal end of the outer holder 4 moves a sleeve 7 toward the housing 6, the sleeve being slidably attached to the small diameter portion 2A of each coaxial connector 2. As a consequence, the claw portion 6A of the housing 6 is pushed and widened from its inside by the sleeve 7 to deform to such a shape that does not interfere with the large diameter portion 2B of the coaxial connector 2.

Then, the outer holder 4 is moved away from the housing 6, whereby the coaxial connectors 2 can be collectively removed from the housing 6.

However, it is necessary to form, in the housing 6, a plurality of claw portions 6A corresponding to the coaxial connectors 2 and also necessary to slidably attach a plurality of sleeves 7 to the coaxial connectors 2. In addition, the outer holder 4 needs to be disposed slidably with respect to the inner holder 3 retaining the coaxial connectors 2, and this results in a complex structure of the multi-connector.

Furthermore, if not all of the sleeves 7 exhibit the desired function, the collective removal of the coaxial connectors 2 from the housing 6 may fail.

### SUMMARY OF THE INVENTION

The present invention has been made to overcome such a conventional problem and is aimed at providing a removal adapter that enables collective removal of a plurality of first connectors fitted with a plurality of second connectors from the second connectors, despite its simple structure.

The present invention is also aimed at providing a connector assembly including the removal adapter.

A removal adapter according to the present invention is a removal adapter for collectively removing a plurality of first connectors fitted, along a fitting direction, with a plurality of second connectors attached to an electronic device, from the plurality of second connectors, the removal adapter comprising:
a base member fixed to the electronic device;
a cover member having a plurality of first through holes in which the plurality of first connectors are inserted, the cover member being disposed to contact the base member in the fitting direction in a fitting state between the plurality of first connectors and the plurality of second connectors;
a cover member moving mechanism having a set screw screwed and held in a screw hole formed in one of the base member and the cover member, the cover member moving mechanism being configured to move the cover member away from the base member along the fitting direction when the set screw is rotated to be moved; and
a fall-off preventing portion configured to prevent the set screw from falling off the screw hole in a state where the cover member is in contact with the base member,
wherein each of the plurality of first through holes has a dimension smaller than that of a widest portion of each of the plurality of first connectors, and
when the cover member is moved using the cover member moving mechanism, the plurality of first connectors are moved together with the cover member in the fitting direction and removed from the plurality of second connectors.

A connector assembly according to the present invention comprises:
the plurality of first connectors;
the plurality of second connectors; and
the removal adapter.

### BRIEF DESCRIPTION OF THE DRAWINGS

FIG. 1 is a perspective view showing a connector assembly according to Embodiment 1.

FIG. 2 is a plan view showing the connector assembly according to Embodiment 1.

FIG. 3 is a front view showing the connector assembly according to Embodiment 1.

FIG. 4 is a side view showing the connector assembly according to Embodiment 1.

FIG. 5 is a perspective view of a base member used in Embodiment 1, as viewed from an obliquely upper position.

FIG. 6 is a perspective view of the base member used in Embodiment 1, as viewed from an obliquely lower position.

FIG. 7 is a perspective view of a cover member used in Embodiment 1, as viewed from an obliquely upper position.

FIG. 8 is a perspective view of the cover member used in Embodiment 1, as viewed from an obliquely lower position.

FIG. 9 is a cross-sectional front view showing an important part of the connector assembly of Embodiment 1 in a fitting state.

FIG. 10 is a cross-sectional view showing a first connector and a second connector in the fitting state.

FIG. 11 is an enlarged view of an important part of FIG. 10.

FIG. 12 is a cross-sectional view showing the first connector and the second connector in a removal state.

FIG. 13 is a perspective view showing a connector assembly according to Embodiment 2.

FIG. 14 is a plan view showing the connector assembly according to Embodiment 2.

FIG. 15 is a front view showing the connector assembly according to Embodiment 2.

FIG. 16 is a side view showing the connector assembly according to Embodiment 2.

FIG. 17 is a perspective view of a base member used in Embodiment 2, as viewed from an obliquely upper position.

FIG. 18 is a perspective view of the base member used in Embodiment 2, as viewed from an obliquely lower position.

FIG. 19 is a perspective view of a cover member used in Embodiment 2, as viewed from an obliquely upper position.

FIG. 20 is a perspective view of the cover member used in Embodiment 2, as viewed from an obliquely lower position.

FIG. 21 is a cross-sectional front view showing an important part of the connector assembly of Embodiment 2 in a fitting state.

FIG. 22 is a perspective view showing a connector assembly according to Embodiment 3.

FIG. 23 is a plan view showing the connector assembly according to Embodiment 3.

FIG. 24 is a cross-sectional front view showing an important part of the connector assembly of Embodiment 3 in a fitting state.

FIG. 25 is a perspective view showing a connector assembly according to Embodiment 4.

FIG. 26 is a plan view showing the connector assembly according to Embodiment 4.

FIG. 27 is a front view showing the connector assembly according to Embodiment 4.

FIG. 28 is a side view showing the connector assembly according to Embodiment 4.

FIG. 29 is a perspective view of a base member used in Embodiment 4, as viewed from an obliquely upper position.

FIG. 30 is a perspective view of the base member used in Embodiment 4, as viewed from an obliquely lower position.

FIG. 31 is a perspective view of a cover member used in Embodiment 4, as viewed from an obliquely upper position.

FIG. 32 is a perspective view of the cover member used in Embodiment 4, as viewed from an obliquely lower position.

FIG. 33 is a cross-sectional front view showing an important part of the connector assembly of Embodiment 4 in a fitting state.

FIG. 34 is a perspective view showing a connector assembly according to Embodiment 5.

FIG. 35 is a plan view showing the connector assembly according to Embodiment 5.

FIG. 36 is a front view showing the connector assembly according to Embodiment 5.

FIG. 37 is a side view showing the connector assembly according to Embodiment 5.

FIG. 38 is a perspective view of a base member used in Embodiment 5, as viewed from an obliquely upper position.

FIG. 39 is a perspective view of the base member used in Embodiment 5, as viewed from an obliquely lower position.

FIG. 40 is a perspective view of a cover member used in Embodiment 5, as viewed from an obliquely upper position.

FIG. 41 is a perspective view of the cover member used in Embodiment 5, as viewed from an obliquely lower position.

FIG. 42 is a cross-sectional front view showing an important part of the connector assembly of Embodiment 5 in a fitting state.

FIG. 43 is a perspective view showing a connector assembly according to Embodiment 6.

FIG. 44 is a plan view showing the connector assembly according to Embodiment 6.

FIG. 45 is a front view showing the connector assembly according to Embodiment 6.

FIG. 46 is a side view showing the connector assembly according to Embodiment 6.

FIG. 47 is a perspective view of a base member used in Embodiment 6, as viewed from an obliquely upper position.

FIG. 48 is a perspective view of the base member used in Embodiment 6, as viewed from an obliquely lower position.

FIG. 49 is a perspective view of a cover member used in Embodiment 6, as viewed from an obliquely upper position.

FIG. 50 is a perspective view of the cover member used in Embodiment 6, as viewed from an obliquely lower position.

FIG. 51 is a cross-sectional front view showing an important part of the connector assembly of Embodiment 6 in a fitting state.

FIG. 52 is a cross-sectional front view showing a conventional multi-connector.

FIG. 53 is a partial cross-sectional view showing the conventional multi-connector during removal.

### DETAILED DESCRIPTION OF THE INVENTION

Embodiments of the invention are described below based on the accompanying drawings.

### Embodiment 1

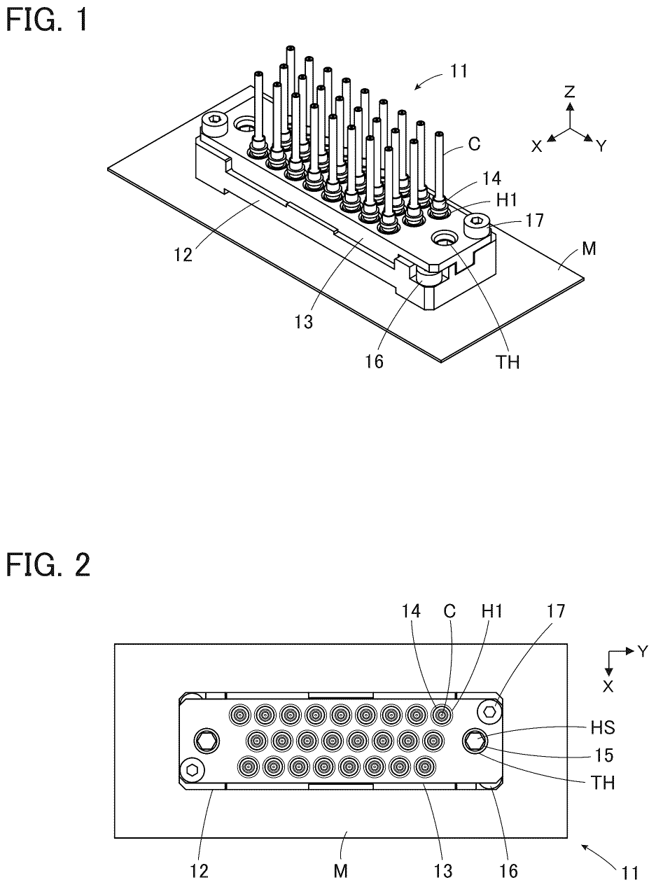

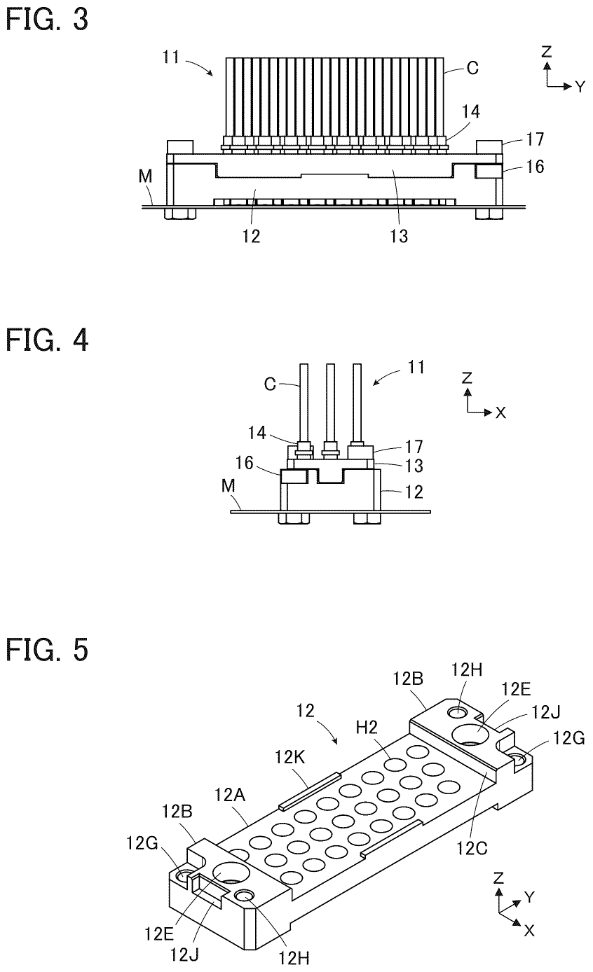

FIGS. 1 to 4 show a connector assembly 11 according to Embodiment 1. The connector assembly 11 includes a base member 12 fixed onto a flat mounting surface M of an electronic device, and a cover member 13 disposed on the base member 12. The cover member 13 is provided with a plurality of first through holes H1 aligned in three rows along a predetermined direction, and a plurality of first connectors 14 attached to the distal ends of a plurality of cables C are inserted in the first through holes H1 of the cover member 13.

A plurality of second connectors to be described later are mounted on the mounting surface M, and the first connectors 14 inserted in the first through holes H1 of the cover member 13 are separately fitted with the second connectors.

For convenience, a plane in which the mounting surface M of the electronic device extends is referred to as an XY plane, a direction in which the first through holes H1 of the cover member 13 are aligned as a Y direction, and a direction perpendicular to the mounting surface M and extending from the base member 12 toward the cover member 13 as a +Z direction.

The base member 12 and the cover member 13 extend along the Y direction, and the cables C extend in the +Z direction from the first connectors 14. The Z direction is a fitting direction in which the first connectors 14 and the second connectors 21 are fitted together.

As shown in FIG. 2, two tool through holes TH are formed to penetrate the cover member 13 in the Z direction in the opposite end portions, in the Y direction, of the cover member 13, and hexagon sockets HS of two set screws 15 are exposed toward the +Z direction through the tool through holes TH.

The base member 12 is fixed onto the mounting surface M of the electronic device by two base member fixing screws 16, and the cover member 13 is fixed to the base member 12 by two cover member fixing screws 17.

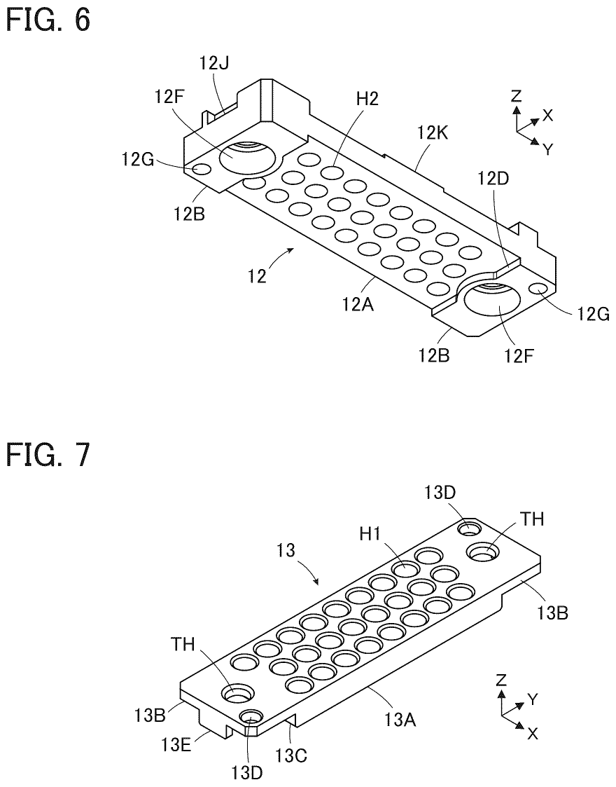

As shown in FIGS. 5 and 6, the base member 12 is made of an insulating material such as an insulating resin and includes a base body 12A of flat plate shape that extends in the Y direction along an XY plane and support portions 12B of substantially cuboid shape that are separately and integrally joined to the +Y directional end portion and the −Y directional end portion of the base body 12A. The base body 12A is provided with a plurality of second through holes H2 that are aligned in three rows along the Y direction and penetrate the base body 12A in the Z direction.

Each support portion 12B has a width in the X direction that is the same as the width of the base body 12A in the X direction and has a thickness in the Z direction that is larger than the thickness of the base body 12A in the Z direction.

Specifically, each support portion 12B protrudes from the base body 12A on both +Z and −Z direction sides; thus, a step portion 12C is formed between the surface of the support portion 12B on the +Z direction side and the surface of the base body 12A on the +Z direction side, while a step portion 12D is also formed between the surface of the support portion 12B on the −Z direction side and the surface of the base body 12A on the −Z direction side.

Each support portion 12B is provided, in its middle portion in the X direction, with a screw hole 12E extending in the −Z direction from the surface, on the +Z direction side, of the support portion 12B up to a Z-directionally intermediate portion of the support portion 12B. The screw hole 12E is used to receive the set screw 15 screwed therein.

The support portion 12B is provided, at its surface on the −Z direction side, with a circular recess portion 12F having a diameter larger than that of the screw hole 12E, and the recess portion 12F communicates with the screw hole 12E.

Each support portion 12B is further provided, in its opposite end portions in the X direction, with a through hole 12G penetrating the support portion 12B in the Z direction and a fixation hole 12H extending in the −Z direction from the surface, on the +Z direction side, of the support portion 12B and having a threaded inner peripheral surface. The through hole 12G is used to allow the base member fixing screw 16 to pass therethrough, and the fixation hole 12H is used to receive the cover member fixing screw 17 screwed therein.

The support portion 12B disposed on the +Y direction side is provided with a cutout 12J cut to open toward both the +Y direction and the +Z direction, while the support portion 12B disposed on the −Y direction side is provided with the cutout 12J cut to open toward both the −Y direction and the +Z direction.

In addition, the +X directional end portion and the −X directional end portion of the base body 12A are provided separately with projections 12K extending in the Y direction and projecting in the +Z direction.

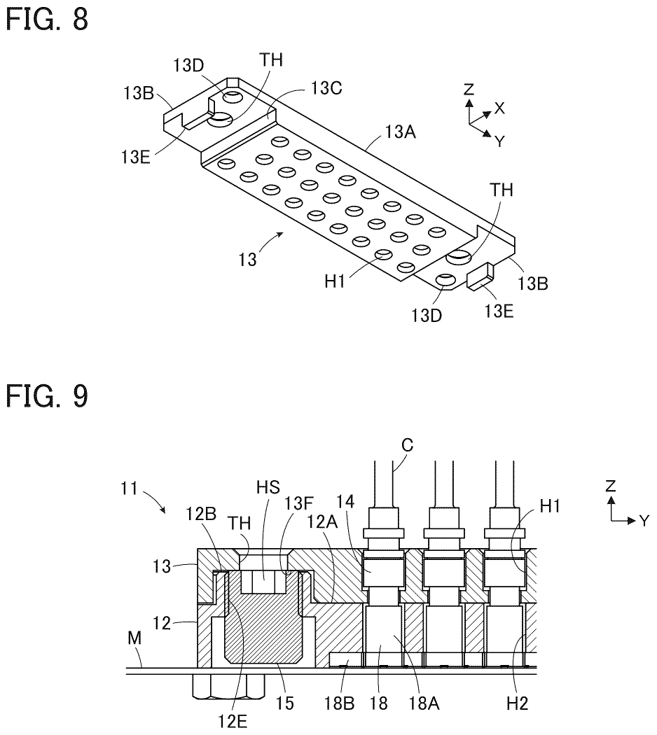

As shown in FIGS. 7 and 8, the cover member 13 is made of an insulating material such as an insulating resin and includes a cover body 13A of flat plate shape that extends in the Y direction along an XY plane and support portions 13B of flat plate shape that are separately and integrally joined to the +Y directional end portion and the −Y directional end portion of the cover body 13A. The cover body 13A is provided with the first through holes H1 that are aligned in three rows along the Y direction and penetrate the cover body 13A in the Z direction.

Each support portion 13B has a width in the X direction that is the same as the width of the cover body 13A in the X direction and has a thickness in the Z direction that is smaller than the thickness of the cover body 13A in the Z direction.

Specifically, while the cover body 13A has the surface on the +Z direction side that forms the same plane with the surface of each support portion 13B on the +Z direction side, the cover body 13A protrudes with respect to each support portion 13B on the −Z direction side, so that a step portion 13C is formed between the surface of the cover body 13A on the −Z direction side and the surface of each support portion 13B on the −Z direction side.

Each support portion 13B is provided, in its middle portion in the X direction, with the tool through hole TH penetrating the support portion 13B in the Z direction. The tool through hole TH is used to allow a screw rotating tool (not shown) such as a hexagon wrench to be inserted therein in order to rotate the set screw 15 screwed and held in the screw hole 12E of the base member 12.

Each support portion 13B is also provided with a through hole 13D penetrating the support portion 13B in the Z direction. The through hole 13D is used to allow the cover member fixing screw 17 to pass therethrough to be screwed in the fixation hole 12H of the base member 12.

In addition, projections 13E projecting in the −Z direction are formed separately at the +Y directional end portion of the support portion 13B disposed on the +Y direction side and the −Y directional end portion of the support portion 13B disposed on the −Y direction side.

The Y-directional length of the cover body 13A is slightly smaller than the Y-directional length of the base body 12A, the X-directional length of the cover body 13A is slightly smaller than a gap in the X direction between the pair of projections 12K of the base body 12A, and the step portion 13C of the cover member 13 has a substantially same Z-directional height as the step portion 12C of the base member 12. Thus, the cover member 13 is configured to be aligned with the base member 12 and stacked on the base member 12 when disposed on the +Z direction side of the base member 12.

When the cover member 13 is disposed to be stacked on the base member 12, the first through holes H1 of the cover member 13 correspond in position to the second through holes H2 of the base member 12, and the pair of tool through holes TH of the cover member 13 correspond in position to the pair of screw holes 12E of the base member 12. Further, the pair of through holes 13D of the cover member 13 also correspond in position to the pair of fixation holes 12H of the base member 12, and the pair of projections 13E of the cover member 13 are inserted in the pair of cutouts 12J of the base member 12.

Now, a method of assembling the connector assembly 11 is described.

First, it is assumed that the second connectors 18 are mounted on the mounting surface M of the electronic device in such a manner as to correspond to the second through holes H2 of the base member 12 as shown in FIG. 9.

The second connectors 18 each include a cylindrical fitting portion 18A and a flange portion 18B protruding from the −Z directional end portion of the fitting portion 18A along an XY plane, and are mounted with their flange portions 18B being in contact with the mounting surface M.

The base member 12 is disposed on the mounting surface M while the fitting portions 18A of the second connectors 18 are inserted into the second through holes H2 of the base member 12, and the base member 12 is fixed onto the mounting surface M by use of the base member fixing screws 16 (FIGS. 1 to 4) passed through the through holes 12G of the base member 12. Thus, the flange portions 18B of the second connectors 18 are sandwiched between the surface, on the −Z direction side, of the base body 12A of the base member 12 and the mounting surface M and retained on the mounting surface M owing to the base member 12.

It should be noted that the set screws 15 are screwed and held separately in the screw holes 12E in the pair of support portions 12B of the base member 12 in advance. Alternatively, the set screws 15 may be screwed into the screw holes 12E from the +Z direction after the base member 12 is fixed to the mounting surface M. The set screw 15 is screwed into the screw hole 12E such that, for instance, a head portion of the set screw 15 forms the same plane with the surface, on the +Z direction side, of the support portion 12B of the base member 12 or is slightly recessed in the −Z direction with respect to the surface, on the +Z direction side, of the support portion 12B.

The set screw 15 herein is also referred to as a so-called “IMONEJI” and is a machine element part used to fasten a component. The set screw 15 is a screw having a head portion not protruding in a radial direction from a threaded portion and having, for instance, the same diameter as that of the threaded portion. The head portion is provided with a hexagon socket HS used to rotate the set screw. Instead of the hexagon socket HS, a cross recess, a groove in a minus shape (slot), or the like may be formed in the head portion.

Next, the cover member 13 is disposed on the +Z direction side of the base member 12 to be stacked on the base member 12, and the cover member fixing screws 17 (FIGS. 1 to 4) passed through the through holes 13D of the cover member 13 are screwed into the fixation holes 12H of the base member 12, whereby the cover member 13 is fixed with respect to the base member 12.

At this time, the cover member 13 makes contact with the base member 12, and the first through holes H1 of the cover member 13 are separately situated immediately above, that is, on the +Z direction side of the corresponding second through holes H2 of the base member 12.

Further, as shown in FIG. 9, the tool through hole TH of the cover member 13 is situated immediately above the screw hole 12E of the base member 12. The tool through hole TH has a diameter smaller than that of the set screw 15 screwed and held in the screw hole 12E, so that a part of the screw hole 12E is covered by the cover member 13 in the Z direction. Thus, the part of the cover member 13 which covers the part of the screw hole 12E forms a screw receiving portion 13F, and the tool through hole TH is formed in the screw receiving portion 13F.

The set screw 15 has a central axis extending along the Z direction, and the outer peripheral surface of the set screw 15 is provided with a male thread centered on the central axis over the entire Z-directional length of the set screw 15, while the inner peripheral surface of the screw hole 12E of the base member 12 is provided with a female thread corresponding to the male thread of the set screw 15. The hexagon socket HS of the set screw 15 screwed and held in the screw hole 12E is exposed in the +Z direction through the tool through hole TH.

The first connectors 14 attached to the distal ends of the cables C are inserted from the +Z direction into the first through holes H1 of the cover member 13 thus fixed to the base member 12, whereby the first connectors 14 can be fitted to the second connectors 18 separately.

Thus, the assembling operation of the connector assembly 11 is completed.

It should be noted that the base member 12, the cover member 13, and the two set screws 15 constitute a removal adapter used to collectively remove the first connectors 14 fitted with the second connectors 18 from the second connectors 18.

In addition, the screw hole 12E of the base member 12, the set screw 15 screwed in the screw hole 12E, and the screw receiving portion 13F of the cover member 13 constitute a cover member moving mechanism used to move the cover member 13 away from the base member 12 along the fitting direction. While the cover member moving mechanism is disposed at the −Y directional end of the connector assembly 11 as shown in FIG. 9, the same cover member moving mechanism is also disposed at the +Y directional end of the connector assembly 11.

Further, the screw receiving portion 13F constitutes a fall-off preventing portion that prevents the set screw 15 from falling off the screw hole 12E.

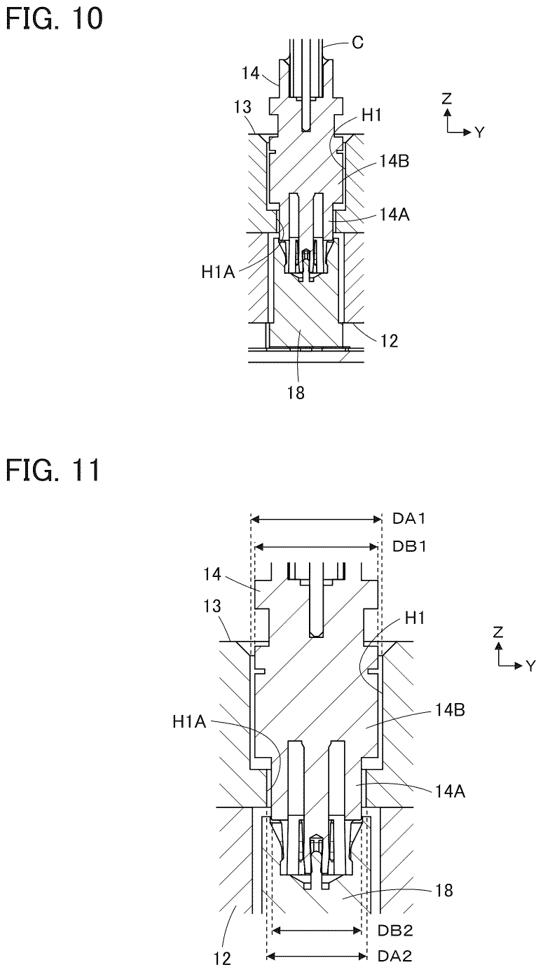

Now, the first connector 14 and the second connector 18 fitted together are shown in FIG. 10. The first connector 14 and the second connector 18 are also referred to as so-called “push-on connectors” configured such that the connectors 14 and 18 are fitted together only by being pushed to each other along the fitting direction, while their fitting is released only by application of a force to separate the connectors 14 and 18 from each other along the fitting direction.

The first connector 14 is attached to the distal end of the cable C and includes a small diameter portion 14A that is disposed on the −Z direction side close to the second connector 18 and a large diameter portion 14B that is disposed on the opposite side from the second connector 18 with respect to the small diameter portion 14A, i.e., on the +Z direction side and that forms the widest portion of the first connector 14. The large diameter portion 14B has a diameter larger than that of the small diameter portion 14A.

The first through hole H1 of the cover member 13 has a restricted portion H1A formed inside the first through hole H1 on the −Z direction side of the first through hole H1.

As shown in FIG. 11, the restricted portion H1A has a diameter DA2 smaller than a diameter DB1 of the large diameter portion 14B of the first connector 14 and slightly larger than a diameter DB2 of the small diameter portion 14A. The portion of the first through hole H1 which is situated on the +Z direction side relative to the restricted portion H1A has a diameter DA1 slightly larger than the diameter DB1 of the large diameter portion 14B of the first connector 14.

Only by inserting the first connectors 14 into the first through holes H1 of the cover member 13 and pushing the first connectors 14 in the −Z direction, the small diameter portions 14A of the first connectors 14 separately pass through the restricted portions H1A of the corresponding first through holes H1, and the first connectors 14 are fitted to the second connectors 18. Consequently, the cables C are electrically connected to a plurality of conductive portions (not shown) of the electronic device having the mounting surface M via the first connectors 14 and the second connectors 18.

Next, the operation of collectively removing the first connectors 14 from the second connectors 18 with respect to the connector assembly 11 in the fitting state is described.

First, the two cover member fixing screws 17 are loosened and removed to release the fixation state of the cover member 13 with respect to the base member 12.

Next, a screw rotating tool (not shown) such as a hexagon wrench is inserted into the tool through hole TH disposed at each of the opposite end portions, in the Y direction, of the cover member 13 and is fitted into the hexagon socket HS of the set screw 15 to rotate the set screw 15, thereby moving the set screw 15 in the +Z direction with respect to the screw hole 12E of the base member 12.

Consequently, the head portion of the set screw 15, that is, the +Z directional end portion of the set screw 15 pushes up, in the +Z direction, the screw receiving portion 13F of the cover member 13 which covers the part of the screw hole 12E, so that the cover member 13 is moved in the +Z direction away from the base member 12.

As described above, the restricted portion H1A formed inside the first through hole H1 of the cover member 13 has the diameter DA2 smaller than the diameter DB1 of the large diameter portion 14B of the first connector 14.

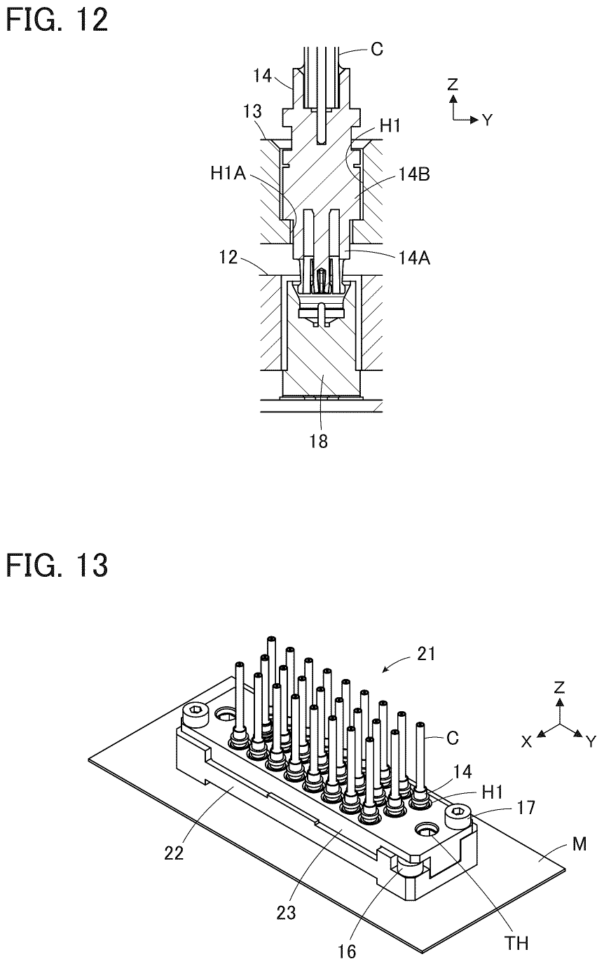

Therefore, the restricted portion H1A of the cover member 13 catches on the large diameter portion 14B of the first connector 14, and the first connector 14 is moved in the +Z direction together with the cover member 13. As a result, the first connector 14 is separated from the second connector 18, so that their fitting is released, as shown in FIG. 12.

When the cover member 13 is moved in the +Z direction away from the base member 12, the restricted portions H1A of the first through holes H1 formed in the cover member 13 separately catch on the large diameter portions 14B of the first connectors 14, so that the first connectors 14 are separated from the second connectors 18. Thus, it is possible to collectively remove the first connectors 14 fitted with the second connectors 18 from the second connectors 18 despite its simple structure.

In Embodiment 1 above, since the cover member 13 is moved in the +Z direction away from the base member 12 by rotating the set screw 15 provided in its head portion with the hexagon socket HS, the first connectors 14 can be collectively removed only with a general tool such as a hexagon wrench, and no dedicated tool is necessary.

Aside from that, the set screw 15 is prevented from falling off the screw hole 12E owing to the fall-off preventing portion constituted of the screw receiving portion 13F of the cover member 13 which covers the part of the screw hole 12E of the base member 12 in the state where the cover member 13 is in contact with the base member 12. Thus, even when the electronic device having the second connectors 18 mounted thereon is installed in a vehicle or the like and the set screw 15 receives vibrations, the set screw 15 can be prevented from falling off the screw hole 12E.

### Embodiment 2

FIGS. 13 to 16 show a connector assembly 21 according to Embodiment 2. The connector assembly 21 is configured such that, in place of the base member 12, a base member 22 is fixed onto the mounting surface M of the electronic device and a cover member 23 is disposed on the base member 22 in the connector assembly 11 of Embodiment 1. The cover member 23 is provided with the first through holes H1 as with the cover member 13 in Embodiment 1, and the first connectors 14 attached to the distal ends of the cables C are inserted in the first through holes H1 of the cover member 23.

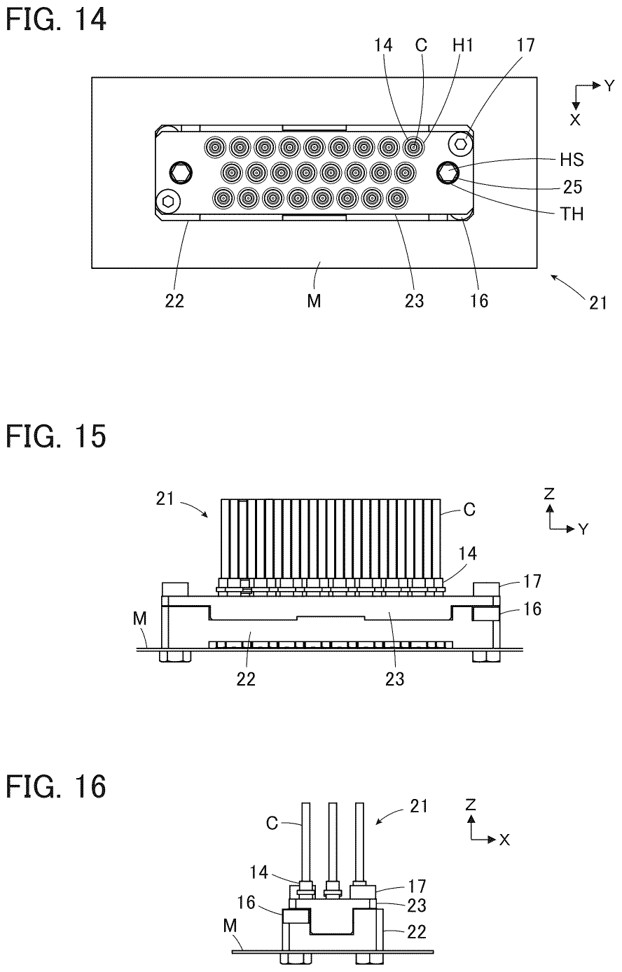

As shown in FIG. 14, the two tool through holes TH are formed to penetrate the cover member 23 in the Z direction in the opposite end portions of the cover member 23 in the Y direction, and hexagon sockets HS of two set screws 25 are exposed toward the +Z direction through the tool through holes TH.

The base member 22 is fixed onto the mounting surface M of the electronic device by the two base member fixing screws 16, and the cover member 23 is fixed to the base member 22 by the two cover member fixing screws 17.

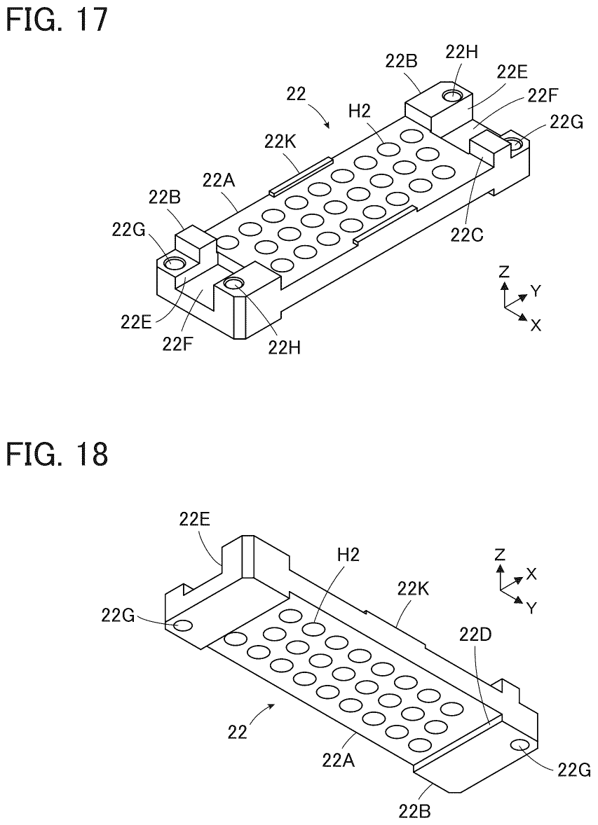

As shown in FIGS. 17 and 18, the base member 22 is made of an insulating material such as an insulating resin and includes a base body 22A of flat plate shape that extends in the Y direction along an XY plane and support portions 22B that are separately and integrally joined to the +Y directional end portion and the −Y directional end portion of the base body 22A. The base body 22A is provided with the second through holes H2 penetrating the base body 22A in the Z direction.

Each support portion 22B protrudes from the base body 22A on both +Z and −Z direction sides; thus, a step portion 22C is formed between the surface of the support portion 22B on the +Z direction side and the surface of the base body 22A on the +Z direction side, while a step portion 22D is also formed between the surface of the support portion 22B on the −Z direction side and the surface of the base body 22A on the −Z direction side.

Each support portion 22B is provided, in its middle portion in the X direction, with a cutout 22E recessed in the −Z direction and opening in the Y direction. The cutout 22E has a bottom surface extending along an XY plane and facing in the +Z direction, and the bottom surface forms a screw receiving portion 22F.

Each support portion 22B is provided, in its opposite end portions in the X direction, with a through hole 22G penetrating the support portion 22B in the Z direction and a fixation hole 22H extending in the −Z direction from the surface, on the +Z direction side, of the support portion 22B and having a threaded inner peripheral surface. The through hole 22G is used to allow the base member fixing screw 16 to pass therethrough, and the fixation hole 22H is used to receive the cover member fixing screw 17 screwed therein.

In addition, the +X directional end portion and the −X directional end portion of the base body 22A are provided separately with projections 22K extending in the Y direction and projecting in the +Z direction.

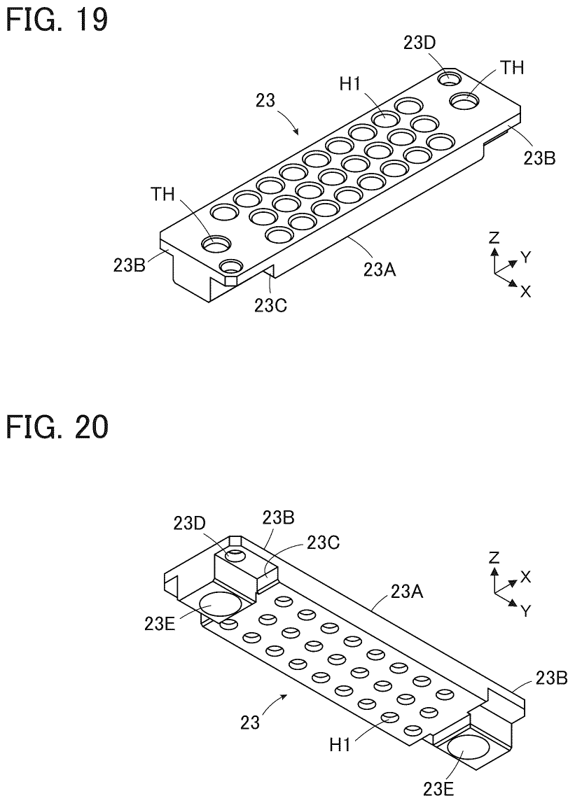

As shown in FIGS. 19 and 20, the cover member 23 is made of an insulating material such as an insulating resin and includes a cover body 23A of flat plate shape that extends in the Y direction along an XY plane and support portions 23B that are separately and integrally joined to the +Y directional end portion and the −Y directional end portion of the cover body 23A. The cover body 23A is provided with the first through holes H1 penetrating the cover body 23A in the Z direction.

A step portion 23C is formed between the surface of the cover body 23A on the −Z direction side and the surface of each support portion 23B on the −Z direction side.

Each support portion 23B is provided, in its middle portion in the X direction, with the tool through hole TH that opens at the surface of the support portion 23B on the +Z direction side, and further with a screw hole 23E that communicates with the tool through hole TH and extends up to the surface of the support portion 23B on the −Z direction side.

The screw hole 23E is used to receive the set screw 25 screwed therein and has a diameter larger than that of the tool through hole TH.

Each support portion 23B is also provided with a through hole 23D penetrating the support portion 23B in the Z direction.

The cover member 23 is configured to be aligned with the base member 22 and stacked on the base member 22 when disposed on the +Z direction side of the base member 22.

Now, a method of assembling the connector assembly 21 is described.

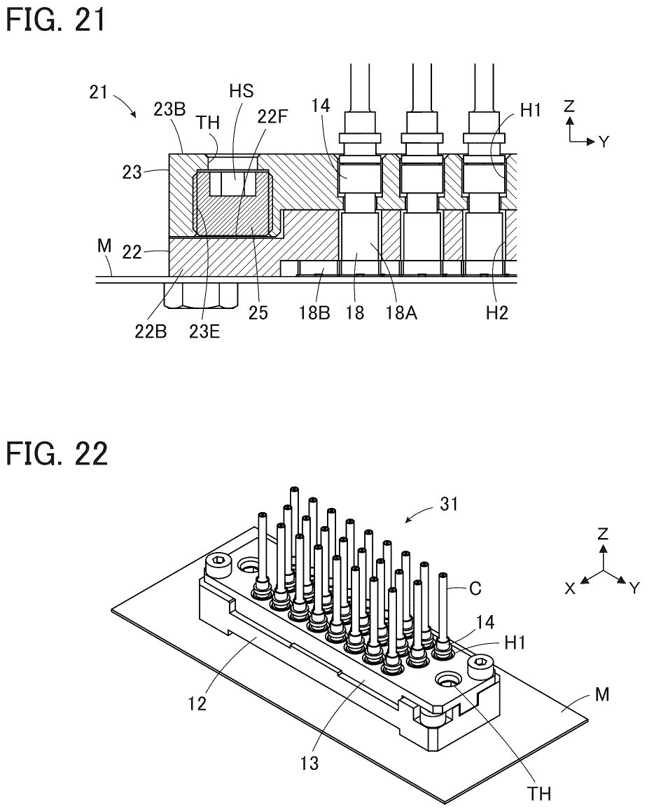

As shown in FIG. 21, the base member 22 is disposed on the mounting surface M while the fitting portions 18A of the second connectors 18 are inserted into the second through holes H2 of the base member 22, and the base member 22 is fixed onto the mounting surface M by use of the base member fixing screws 16 (FIGS. 13 to 16). Further, the cover member 23 is disposed to be stacked on the base member 22, and the cover member 23 is fixed with respect to the base member 22 by use of the cover member fixing screws 17 (FIGS. 13 to 16).

It should be noted that the set screws 25 are screwed and held separately in the screw holes 23E in the pair of support portions 23B of the cover member 23 in advance. The set screw 25 has a central axis extending along the Z direction, and the outer peripheral surface of the set screw 25 is provided with a male thread centered on the central axis over the entire Z-directional length of the set screw 25, while the inner peripheral surface of the screw hole 23E of the cover member 23 is provided with a female thread corresponding to the male thread of the set screw 25.

The set screw 25 is screwed into the screw hole 23E such that, for instance, the distal end of the set screw 25 forms the same plane with the screw receiving portion 22F of the support portion 22B of the base member 22 or is situated slightly toward the +Z direction relative to the screw receiving portion 22F. The head portion of the set screw 25 is situated immediately below the tool through hole TH of the cover member 23, so that the hexagon socket HS of the set screw 25 is exposed in the +Z direction through the tool through hole TH.

The first connectors 14 are inserted from the +Z direction into the first through holes H1 of the cover member 23 thus fixed to the base member 22, whereby the first connectors 14 are fitted to the second connectors 18 separately, and the assembling operation of the connector assembly 21 is completed.

It should be noted that the base member 22, the cover member 23, and the two set screws 25 constitute a removal adapter used to collectively remove the first connectors 14 from the second connectors 18.

In addition, the screw hole 23E of the cover member 23, the set screw 25 screwed in the screw hole 23E, and the screw receiving portion 22F of the base member 22 constitute a cover member moving mechanism used to move the cover member 23 away from the base member 22 along the fitting direction.

Further, the part of the cover member 23 which is situated around the tool through hole TH constitutes a fall-off preventing portion that prevents the set screw 25 from falling off the screw hole 23E. While the cover member moving mechanism is disposed at the −Y directional end of the connector assembly 21 as shown in FIG. 21, the same cover member moving mechanism is also disposed at the +Y directional end of the connector assembly 21.

When the first connectors 14 are collectively removed from the second connectors 18 with respect to the connector assembly 21 in the fitting state, first, the two cover member fixing screws 17 are removed to release the fixation state of the cover member 23 with respect to the base member 22. Thereafter, a screw rotating tool (not shown) such as a hexagon wrench is inserted into each of the two tool through holes TH of the cover member 23 and is fitted into the hexagon socket HS of the set screw 25 to rotate the set screw 25, thereby moving the set screw 25 in the −Z direction with respect to the screw hole 23E of the cover member 23.

Consequently, the distal end of the set screw 25, that is, the −Z directional end portion of the set screw 25 presses the screw receiving portion 22F of the base member 22 in the −Z direction, and due to the reaction force thereof, the cover member 23 is moved in the +Z direction away from the base member 22.

As a result, the first connectors 14 are removed from the second connectors 18 in the same manner as the connector assembly 11 of Embodiment 1.

Thus, also in Embodiment 2, it is possible to collectively remove the first connectors 14 fitted with the second connectors 18 from the second connectors 18 despite its simple structure.

In addition, the set screw 25 is prevented from falling off the screw hole 23E owing to the fall-off preventing portion constituted of the part of the cover member 23 which is situated around the tool through hole TH in the state where the cover member 23 is in contact with the base member 22.

### Embodiment 3

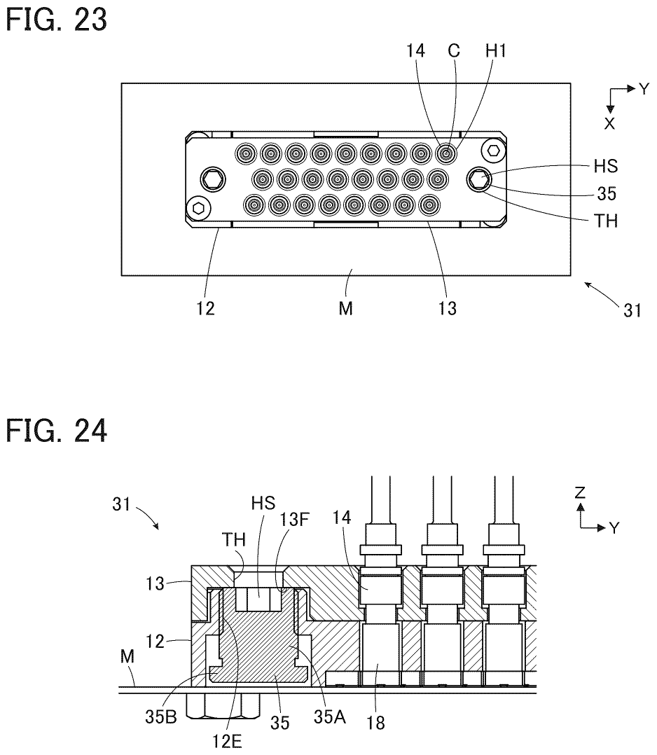

FIGS. 22 and 23 show a connector assembly 31 according to Embodiment 3. The connector assembly 31 is configured such that, in place of the set screw 15, a flanged screw 35 is used in the connector assembly 11 of Embodiment 1, and otherwise has the same configuration as the connector assembly 11 of Embodiment 1.

Specifically, the base member 12 is fixed onto the mounting surface M of the electronic device, the cover member 13 is disposed on the base member 12, and the first connectors 14 attached to the distal ends of the cables C are inserted in the first through holes H1 of the cover member 13.

As shown in FIG. 23, hexagon sockets HS of two flanged screws 35 are exposed toward the +Z direction through the two tool through holes TH formed in the opposite end portions, in the Y direction, of the cover member 13.

As shown in FIG. 24, the flanged screw 35 includes a thread portion 35A of round columnar shape and a flange 35B formed at the −Z directional end portion of the thread portion 35A to protrude in a radial direction along an XY plane from the thread portion 35A. The thread portion 35A has a central axis extending along the Z direction, and the outer peripheral surface of the thread portion 35A is provided with a male thread centered on the central axis over the entire Z-directional length of the thread portion 35A, as with the set screw 15 used in Embodiment 1. The male thread of the thread portion 35A has the same diameter and the same thread pitch as those of the male thread of the set screw 15. In addition, the hexagon socket HS is formed in the +Z directional end portion of the thread portion 35A as with the set screw 15.

It should be noted that the base member 12, the cover member 13, and the two flanged screws 35 constitute a removal adapter used to collectively remove the first connectors 14 from the second connectors 18.

In addition, the screw hole 12E of the base member 12, the flanged screw 35 screwed in the screw hole 12E, and the screw receiving portion 13F of the cover member 13 constitute a cover member moving mechanism used to move the cover member 13 away from the base member 12 along the fitting direction. While the cover member moving mechanism is disposed at the −Y directional end of the connector assembly 31 as shown in FIG. 24, the same cover member moving mechanism is also disposed at the +Y directional end of the connector assembly 31.

When the first connectors 14 are collectively removed from the second connectors 18 with respect to the connector assembly 31 in the fitting state, a screw rotating tool (not shown) is inserted into the tool through hole TH of the cover member 13 and fitted into the hexagon socket HS of the flanged screw 35 to rotate the flanged screw 35, in the same manner as in Embodiment 1.

Consequently, the flanged screw 35 is moved in the +Z direction with respect to the screw hole 12E of the base member 12, and the +Z directional end portion of the flanged screw 35 pushes up, in the +Z direction, the screw receiving portion 13F of the cover member 13 which covers the part of the screw hole 12E, so that the cover member 13 is moved in the +Z direction away from the base member 12.

As a result, the first connectors 14 are removed from the second connectors 18 in the same manner as the connector assembly 11 of Embodiment 1.

Thus, also in Embodiment 3, it is possible to collectively remove the first connectors 14 fitted with the second connectors 18 from the second connectors 18 despite its simple structure.

In addition, since the flanged screw 35 has the flange 35B formed at the −Z directional end portion of the thread portion 35A, the flange 35B serves as a fall-off preventing portion, and the flanged screw 35 is prevented from falling off the screw hole 12E regardless of whether the cover member 13 is in contact with the base member 12 or not.

### Embodiment 4

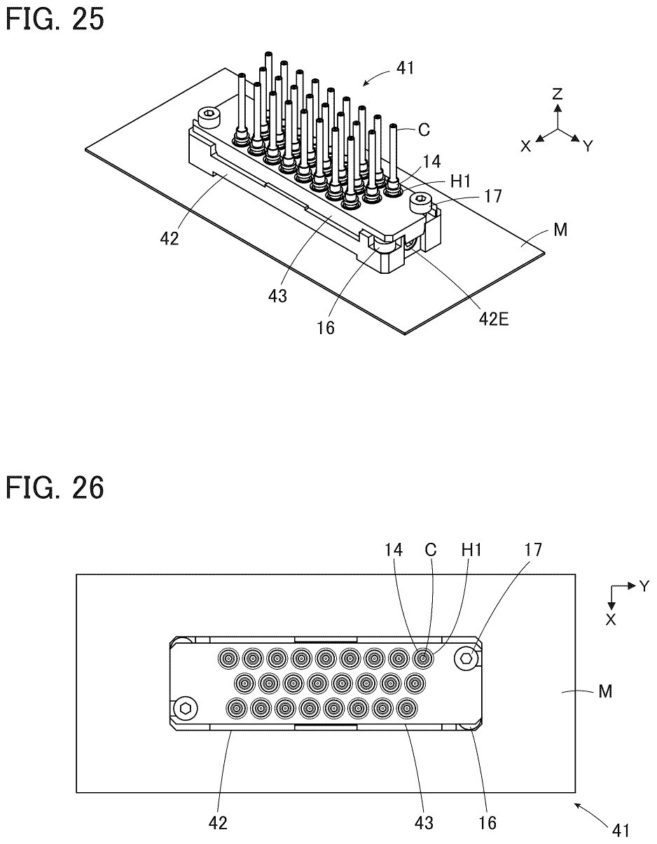

FIGS. 25 to 28 show a connector assembly 41 according to Embodiment 4. The connector assembly 41 is configured such that, in place of the base member 12, a base member 42 is fixed onto the mounting surface M of the electronic device and a cover member 43 is disposed on the base member 42 in the connector assembly 11 of Embodiment 1. The cover member 43 is provided with the first through holes H1 as with the cover member 13 in Embodiment 1, and the first connectors 14 attached to the distal ends of the cables C are inserted in the first through holes H1 of the cover member 43.

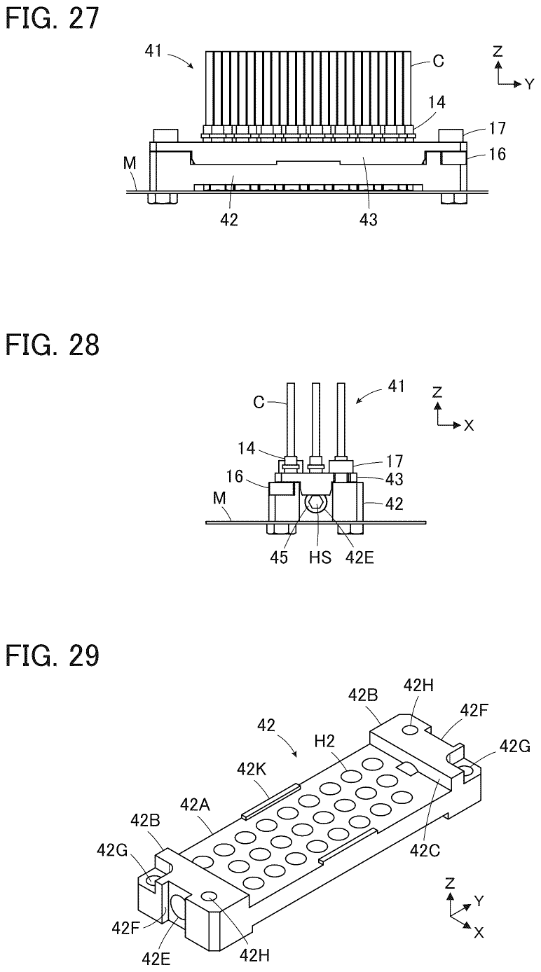

As shown in FIG. 28, a screw hole 42E is formed in each of the −Y directional end portion and the +Y directional end portion of the base member 42. Hexagon sockets HS of two set screws 45 screwed and held separately in the screw holes 42E are exposed in the Y direction.

The base member 42 is fixed onto the mounting surface M of the electronic device by the two base member fixing screws 16, and the cover member 43 is fixed to the base member 42 by the two cover member fixing screws 17.

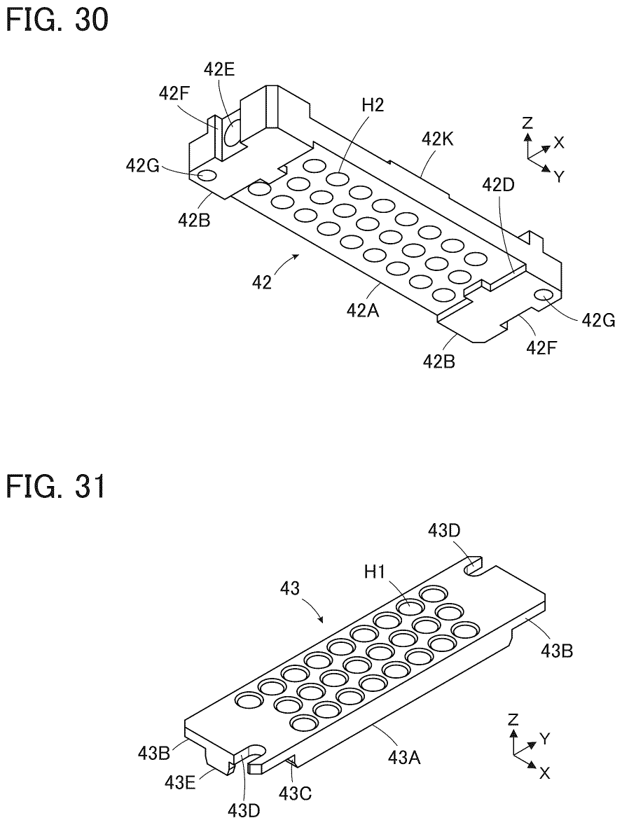

As shown in FIGS. 29 and 30, the base member 42 is made of an insulating material such as an insulating resin and includes a base body 42A of flat plate shape that extends in the Y direction along an XY plane and support portions 42B that are separately and integrally joined to the +Y directional end portion and the −Y directional end portion of the base body 42A. The base body 42A is provided with the second through holes H2 penetrating the base body 42A in the Z direction.

Each support portion 42B protrudes from the base body 42A on both +Z and −Z direction sides; thus, a step portion 42C is formed between the surface of the support portion 42B on the +Z direction side and the surface of the base body 42A on the +Z direction side, while a step portion 42D is also formed between the surface of the support portion 42B on the −Z direction side and the surface of the base body 42A on the −Z direction side.

Each support portion 42B is provided, in its middle portion in the X direction, with a cutout 42F that crosses the support portion 42B in the Z direction and opens in the direction opposite from the base body 42A along the Y direction. The cutout 42F has a bottom surface facing in the Y direction, and a screw hole 42E is formed along the Y direction to open at the bottom surface.

Each support portion 42B is provided, in its opposite end portions in the X direction, with a through hole 42G penetrating the support portion 42B in the Z direction and a fixation hole 42H extending in the −Z direction from the surface, on the +Z direction side, of the support portion 42B and having a threaded inner peripheral surface. The through hole 42G is used to allow the base member fixing screw 16 to pass therethrough, and the fixation hole 42H is used to receive the cover member fixing screw 17 screwed therein.

In addition, the +X directional end portion and the −X directional end portion of the base body 42A are provided separately with projections 42K extending in the Y direction and projecting in the +Z direction.

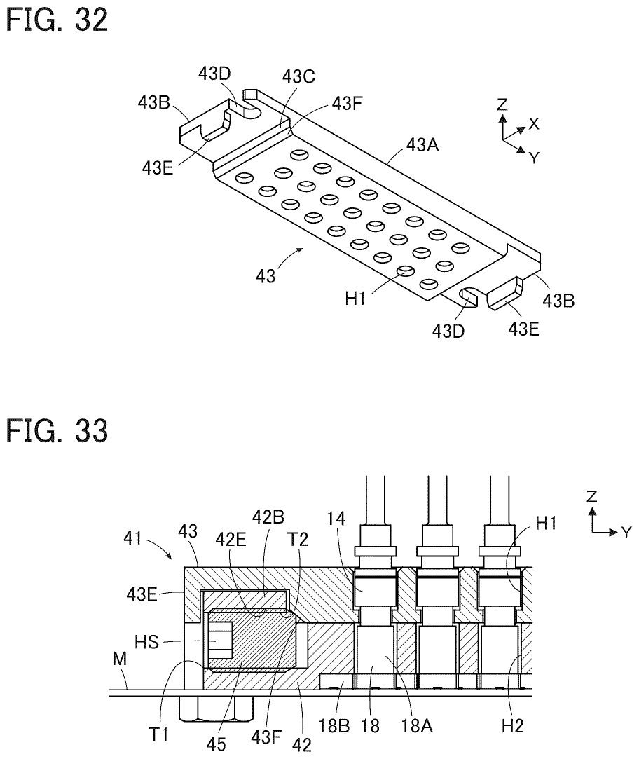

As shown in FIGS. 31 and 32, the cover member 43 is made of an insulating material such as an insulating resin and includes a cover body 43A of flat plate shape that extends in the Y direction along an XY plane and support portions 43B that are separately and integrally joined to the +Y directional end portion and the −Y directional end portion of the cover body 43A. The cover body 43A is provided with the first through holes H1 penetrating the cover body 43A in the Z direction.

A step portion 43C is formed between the surface of the cover body 43A on the −Z direction side and the surface of each support portion 43B on the −Z direction side, and the step portion 43C is provided with a screw receiving portion 43F that has a cam surface extending in the X direction and inclined with respect to the Y direction.

Each support portion 43B is provided with a cutout 43D that allows the cover member fixing screw 17 to be inserted therein and then screwed into the fixation hole 42H of the base member 42.

In addition, projections 43E projecting in the −Z direction are formed separately at the +Y directional end portion of the support portion 43B disposed on the +Y direction side and the −Y directional end portion of the support portion 43B disposed on the −Y direction side.

The cover member 43 is configured to be aligned with the base member 42 and stacked on the base member 42 when disposed on the +Z direction side of the base member 42.

Now, a method of assembling the connector assembly 41 is described.

As shown in FIG. 33, the base member 42 is disposed on the mounting surface M while the fitting portions 18A of the second connectors 18 are inserted into the second through holes H2 of the base member 42, and the base member 42 is fixed onto the mounting surface M by use of the base member fixing screws 16 (FIGS. 25 to 28). Further, the cover member 43 is disposed to be stacked on the base member 42, and the cover member 43 is fixed with respect to the base member 42 by use of the cover member fixing screws 17 (FIGS. 25 to 28).

It should be noted that the set screws 45 are screwed and held separately in the screw holes 42E in the pair of support portions 42B of the base member 42 in advance. The set screw 45 has a central axis extending along the Y direction, and the outer peripheral surface of the set screw 45 is provided with a male thread centered on the central axis over the entire Y-directional length of the set screw 45.

The set screw 45 is screwed into the screw hole 42E such that, for example, a head portion of the set screw 45 forms the same plane with the Y-directional end portion of the support portion 42B of the base member 42 or is situated slightly inside the base member 42 relative to the Y-directional end portion of the support portion 42B.

The screw hole 42E formed in the base member 42 extends along the Y direction from the end portion, in the Y direction, of the base member 42, and the inner peripheral surface of the screw hole 42E is provided with a female thread corresponding to the male thread of the set screw 45. The screw hole 42E has a first end portion T1 situated near the end portion, in the Y direction, of the base member 42 and a second end portion T2 situated on the opposite side from the first end portion T1.

The screw receiving portion 43F of the cover member 43 is disposed at the position facing the second end portion T2 of the screw hole 42E of the base member 42.

A +Z directional portion of the screw hole 42E is covered by the projection 43E of the cover member 43 when viewed from the Y direction, and the hexagon socket HS of the set screw 45 screwed and held in the screw hole 42E is exposed in the Y direction between the projection 43E of the cover member 43 and the mounting surface M.

The first connectors 14 are inserted from the +Z direction into the first through holes H1 of the cover member 43 thus fixed to the base member 42, whereby the first connectors 14 are fitted to the second connectors 18 separately, and the assembling operation of the connector assembly 41 is completed.

It should be noted that the base member 42, the cover member 43, and the two set screws 45 constitute a removal adapter used to collectively remove the first connectors 14 from the second connectors 18.

In addition, the screw hole 42E of the base member 42, the set screw 45 screwed in the screw hole 42E, and the screw receiving portion 43F of the cover member 43 constitute a cover member moving mechanism used to move the cover member 43 away from the base member 42 along the fitting direction. While the cover member moving mechanism is disposed at the −Y directional end of the connector assembly 41 as shown in FIG. 33, the same cover member moving mechanism is also disposed at the +Y directional end of the connector assembly 41.

Further, the projection 43E of the cover member 43 which covers the +Z directional portion of the screw hole 42E when viewed from the Y direction constitutes a fall-off preventing portion that prevents the set screw 45 from falling off the screw hole 42E.

When the first connectors 14 are collectively removed from the second connectors 18 with respect to the connector assembly 41 in the fitting state, first, the two cover member fixing screws 17 are removed to release the fixation state of the cover member 43 with respect to the base member 42. Thereafter, a screw rotating tool (not shown) such as a hexagon wrench is fitted into the hexagon socket HS of the set screw 45, which is exposed in the Y direction between the projection 43E of the cover member 43 and the mounting surface M, to rotate the set screw 45, thereby moving the set screw 45 in the +Y direction with respect to the screw hole 42E of the base member 42.

Consequently, the screw receiving portion 43F of the cover member 43 is pressed in the Y direction by the distal end of the set screw 45. Since the screw receiving portion 43F forms a cam surface inclined with respect to the Y direction, a force toward the +Z direction is exerted by the set screw 45, so that the cover member 43 is moved in the +Z direction away from the base member 42.

As a result, the first connectors 14 are removed from the second connectors 18 in the same manner as the connector assembly 11 of Embodiment 1.

Thus, also in Embodiment 4, it is possible to collectively remove the first connectors 14 fitted with the second connectors 18 from the second connectors 18 despite its simple structure.

In addition, the set screw 45 is prevented from falling off the screw hole 42E owing to the fall-off preventing portion constituted of the projection 43E of the cover member 43 which covers the +Z directional portion of the screw hole 42E in the state where the cover member 43 is in contact with the base member 42.

### Embodiment 5

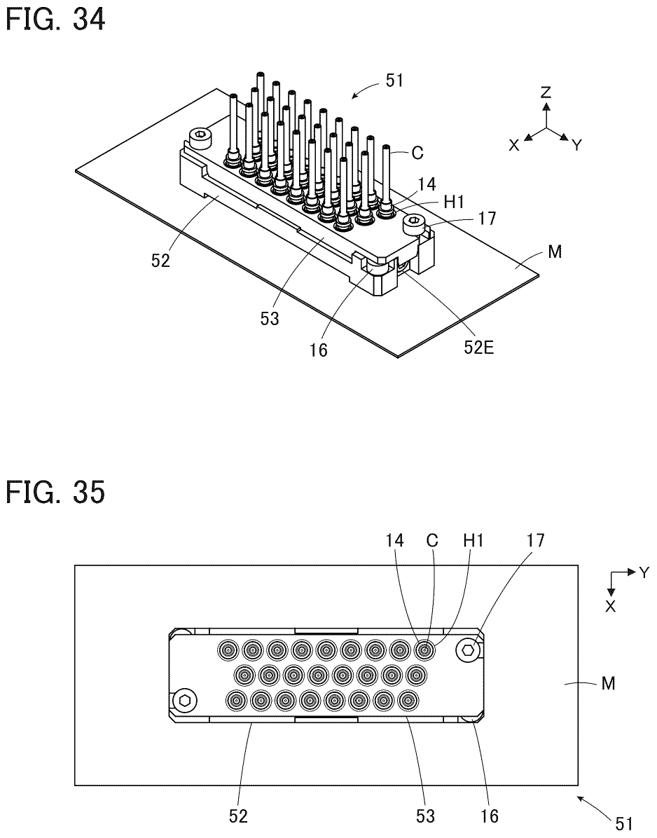

FIGS. 34 to 37 show a connector assembly 51 according to Embodiment 5. The connector assembly 51 is configured such that, in place of the base member 42, a base member 52 is fixed onto the mounting surface M of the electronic device and a cover member 53 is disposed on the base member 52 in the connector assembly 41 of Embodiment 4. The cover member 53 is provided with the first through holes H1 as with the cover member 43 in Embodiment 4, and the first connectors 14 attached to the distal ends of the cables C are inserted in the first through holes H1 of the cover member 53.

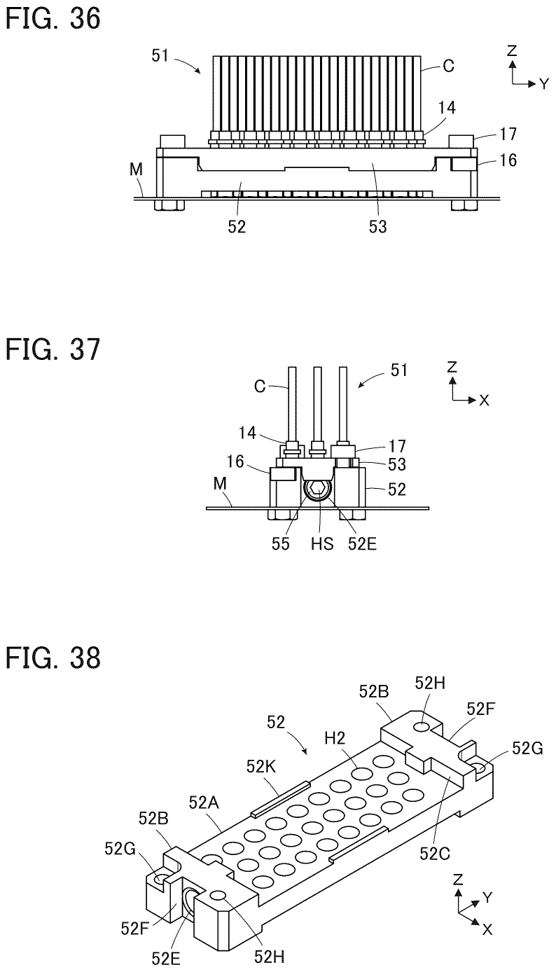

As shown in FIG. 37, a screw hole 52E is formed in each of the −Y directional end portion and the +Y directional end portion of the base member 52. Hexagon sockets HS of two set screws 55 screwed and held separately in the screw holes 52E are exposed in the Y direction.

The base member 52 is fixed onto the mounting surface M of the electronic device by the two base member fixing screws 16, and the cover member 53 is fixed to the base member 52 by the two cover member fixing screws 17.

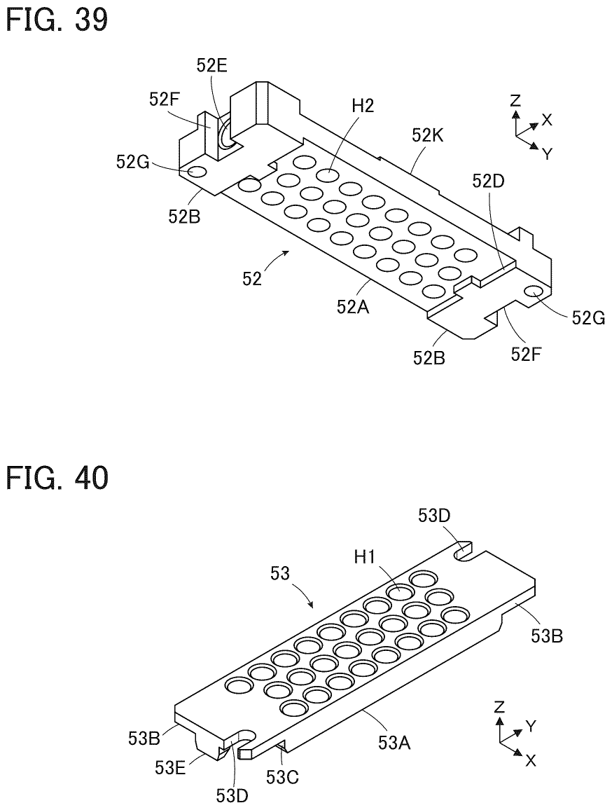

As shown in FIGS. 38 and 39, the base member 52 is made of an insulating material such as an insulating resin and includes a base body 52A of flat plate shape that extends in the Y direction along an XY plane and support portions 52B that are separately and integrally joined to the +Y directional end portion and the −Y directional end portion of the base body 52A. The base body 52A is provided with the second through holes H2 penetrating the base body 52A in the Z direction.

Each support portion 52B protrudes from the base body 52A on both +Z and −Z direction sides; thus, a step portion 52C is formed between the surface of the support portion 52B on the +Z direction side and the surface of the base body 52A on the +Z direction side, while a step portion 52D is also formed between the surface of the support portion 52B on the −Z direction side and the surface of the base body 52A on the −Z direction side.

Each support portion 52B is provided, in its middle portion in the X direction, with a cutout 52F that crosses the support portion 52B in the Z direction and opens in the direction opposite from the base body 52A along the Y direction. The cutout 52F has a bottom surface facing in the Y direction, and a screw hole 52E is formed along the Y direction to open at the bottom surface.

Each support portion 52B is provided, in its opposite end portions in the X direction, with a through hole 52G penetrating the support portion 52B in the Z direction and a fixation hole 52H extending in the −Z direction from the surface, on the +Z direction side, of the support portion 52B and having a threaded inner peripheral surface. The through hole 52G is used to allow the base member fixing screw 16 to pass therethrough, and the fixation hole 52H is used to receive the cover member fixing screw 17 screwed therein.

In addition, the +X directional end portion and the −X directional end portion of the base body 52A are provided separately with projections 52K extending in the Y direction and projecting in the +Z direction.

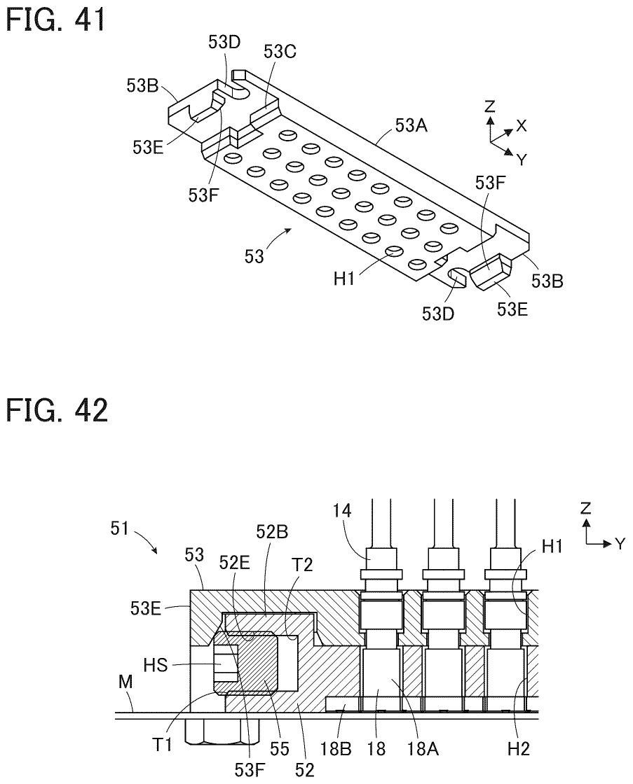

As shown in FIGS. 40 and 41, the cover member 53 is made of an insulating material such as an insulating resin and includes a cover body 53A of flat plate shape that extends in the Y direction along an XY plane and support portions 53B that are separately and integrally joined to the +Y directional end portion and the −Y directional end portion of the cover body 53A. The cover body 53A is provided with the first through holes H1 penetrating the cover body 53A in the Z direction.

A step portion 53C is formed between the surface of the cover body 53A on the −Z direction side and the surface of each support portion 53B on the −Z direction side.

Each support portion 53B is provided with a cutout 53D that allows the cover member fixing screw 17 to be inserted therein and then screwed into the fixation hole 52H of the base member 52.

In addition, projections 53E projecting in the −Z direction are formed separately at the +Y directional end portion of the support portion 53B disposed on the +Y direction side and the −Y directional end portion of the support portion 53B disposed on the −Y direction side. The projection 53E is provided with a screw receiving portion 53F that has a cam surface extending in the X direction and inclined with respect to the Y direction.

The cover member 53 is configured to be aligned with the base member 52 and stacked on the base member 52 when disposed on the +Z direction side of the base member 52.

Now, a method of assembling the connector assembly 51 is described.

As shown in FIG. 42, the base member 52 is disposed on the mounting surface M while the fitting portions 18A of the second connectors 18 are inserted into the second through holes H2 of the base member 52, and the base member 52 is fixed onto the mounting surface M by use of the base member fixing screws 16 (FIGS. 34 to 37). Further, the cover member 53 is disposed to be stacked on the base member 52, and the cover member 53 is fixed with respect to the base member 52 by use of the cover member fixing screws 17 (FIGS. 34 to 37).

It should be noted that the set screws 55 are screwed and held separately in the screw holes 52E in the pair of support portions 52B of the base member 52 in advance. The set screw 55 has a central axis extending along the Y direction, and the outer peripheral surface of the set screw 55 is provided with a male thread centered on the central axis over the entire Y-directional length of the set screw 55.

The screw hole 52E formed in the base member 52 extends along the Y direction from the end portion, in the Y direction, of the base member 52, and the inner peripheral surface of the screw hole 52E is provided with a female thread corresponding to the male thread of the set screw 55. The screw hole 52E has a first end portion T1 situated near the end portion, in the Y direction, of the base member 52 and a second end portion T2 situated on the opposite side from the first end portion T1.

The screw receiving portion 53F formed at the projection 53E of the cover member 53 is disposed at the position facing the first end portion T1 of the screw hole 52E of the base member 52.

A +Z directional portion of the screw hole 52E is covered by the projection 53E of the cover member 53 when viewed from the Y direction, and the hexagon socket HS of the set screw 55 screwed and held in the screw hole 52E is exposed in the Y direction between the projection 53E of the cover member 53 and the mounting surface M.

The first connectors 14 are inserted from the +Z direction into the first through holes H1 of the cover member 53 thus fixed to the base member 52, whereby the first connectors 14 are fitted to the second connectors 18 separately, and the assembling operation of the connector assembly 51 is completed.

It should be noted that the base member 52, the cover member 53, and the two set screws 55 constitute a removal adapter used to collectively remove the first connectors 14 from the second connectors 18.

In addition, the screw hole 52E of the base member 52, the set screw 55 screwed in the screw hole 52E, and the screw receiving portion 53F of the cover member 53 constitute a cover member moving mechanism used to move the cover member 53 away from the base member 52 along the fitting direction. While the cover member moving mechanism is disposed at the −Y directional end of the connector assembly 51 as shown in FIG. 42, the same cover member moving mechanism is also disposed at the +Y directional end of the connector assembly 51.

Further, the projection 53E of the cover member 53 which covers the +Z directional portion of the screw hole 52E when viewed from the Y direction constitutes a fall-off preventing portion that prevents the set screw 55 from falling off the screw hole 52E.

When the first connectors 14 are collectively removed from the second connectors 18 with respect to the connector assembly 51 in the fitting state, first, the two cover member fixing screws 17 are removed to release the fixation state of the cover member 53 with respect to the base member 52. Thereafter, a screw rotating tool (not shown) such as a hexagon wrench is fitted into the hexagon socket HS of the set screw 55, which is exposed in the Y direction between the projection 53E of the cover member 53 and the mounting surface M, to rotate the set screw 55, thereby moving the set screw 55 in the −Y direction with respect to the screw hole 52E of the base member 52.

Consequently, the screw receiving portion 53F of the cover member 53 is pressed in the −Y direction by the head portion of the set screw 55. Since the screw receiving portion 53F forms a cam surface inclined with respect to the Y direction, a force toward the +Z direction is exerted by the set screw 55, so that the cover member 53 is moved in the +Z direction away from the base member 52.

As a result, the first connectors 14 are removed from the second connectors 18 in the same manner as the connector assembly 41 of Embodiment 4.

Thus, also in Embodiment 5, it is possible to collectively remove the first connectors 14 fitted with the second connectors 18 from the second connectors 18 despite its simple structure.

In addition, the set screw 55 is prevented from falling off the screw hole 52E owing to the fall-off preventing portion constituted of the projection 53E of the cover member 53 which covers the +Z directional portion of the screw hole 52E in the state where the cover member 53 is in contact with the base member 52.

### Embodiment 6

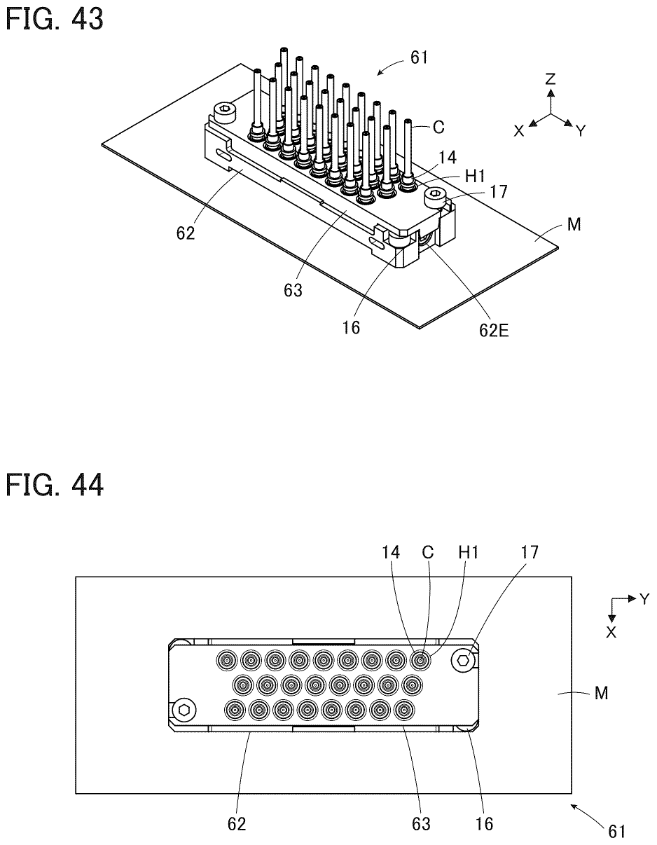

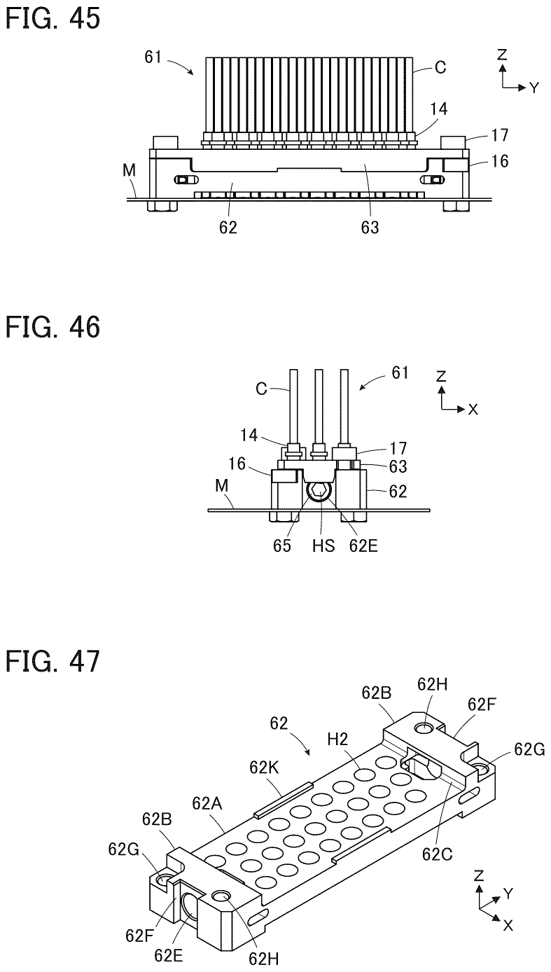

FIGS. 43 to 46 show a connector assembly 61 according to Embodiment 6. The connector assembly 61 is configured such that, in place of the base member 42, a base member 62 is fixed onto the mounting surface M of the electronic device and a cover member 63 is disposed on the base member 62 in the connector assembly 41 of Embodiment 4. The cover member 63 is provided with the first through holes H1 as with the cover member 43 in Embodiment 4, and the first connectors 14 attached to the distal ends of the cables C are inserted in the first through holes H1 of the cover member 63.

As shown in FIG. 46, a screw hole 62E is formed in each of the −Y directional end portion and the +Y directional end portion of the base member 62. Hexagon sockets HS of two set screws 65 screwed and held separately in the screw holes 62E are exposed in the Y direction.

The base member 62 is fixed onto the mounting surface M of the electronic device by the two base member fixing screws 16, and the cover member 63 is fixed to the base member 62 by the two cover member fixing screws 17.

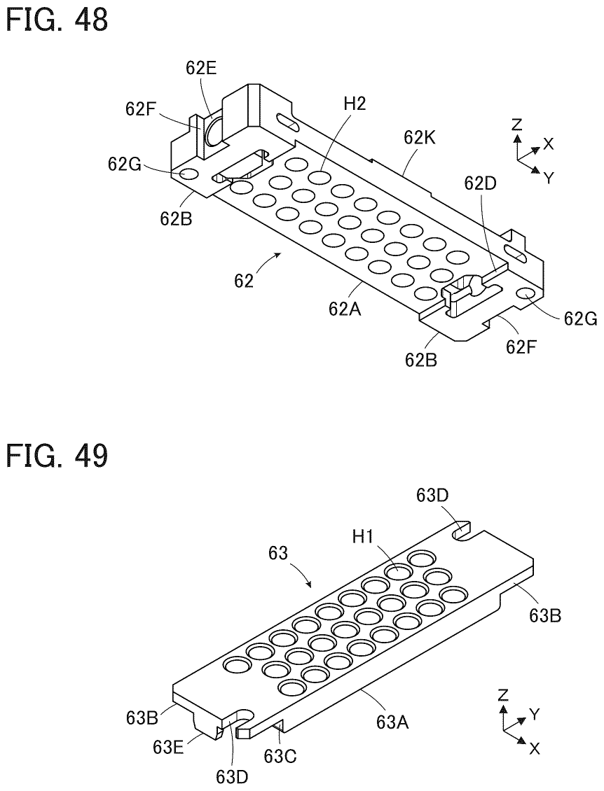

As shown in FIGS. 47 and 48, the base member 62 is made of an insulating material such as an insulating resin and includes a base body 62A of flat plate shape that extends in the Y direction along an XY plane and support portions 62B that are separately and integrally joined to the +Y directional end portion and the −Y directional end portion of the base body 62A. The base body 62A is provided with the second through holes H2 penetrating the base body 62A in the Z direction.

Each support portion 62B protrudes from the base body 62A on both +Z and −Z direction sides; thus, a step portion 62C is formed between the surface of the support portion 62B on the +Z direction side and the surface of the base body 62A on the +Z direction side, while a step portion 62D is also formed between the surface of the support portion 62B on the −Z direction side and the surface of the base body 62A on the −Z direction side.

Each support portion 62B is provided, in its middle portion in the X direction, with a cutout 62F that crosses the support portion 62B in the Z direction and opens in the direction opposite from the base body 62A along the Y direction. The cutout 62F has a bottom surface facing in the Y direction, and a screw hole 62E is formed along the Y direction to open at the bottom surface.

Each support portion 62B is provided, in its opposite end portions in the X direction, with a through hole 62G penetrating the support portion 62B in the Z direction and a fixation hole 62H extending in the −Z direction from the surface, on the +Z direction side, of the support portion 62B and having a threaded inner peripheral surface. The through hole 62G is used to allow the base member fixing screw 16 to pass therethrough, and the fixation hole 62H is used to receive the cover member fixing screw 17 screwed therein.

In addition, the +X directional end portion and the −X directional end portion of the base body 62A are provided separately with projections 62K extending in the Y direction and projecting in the +Z direction.

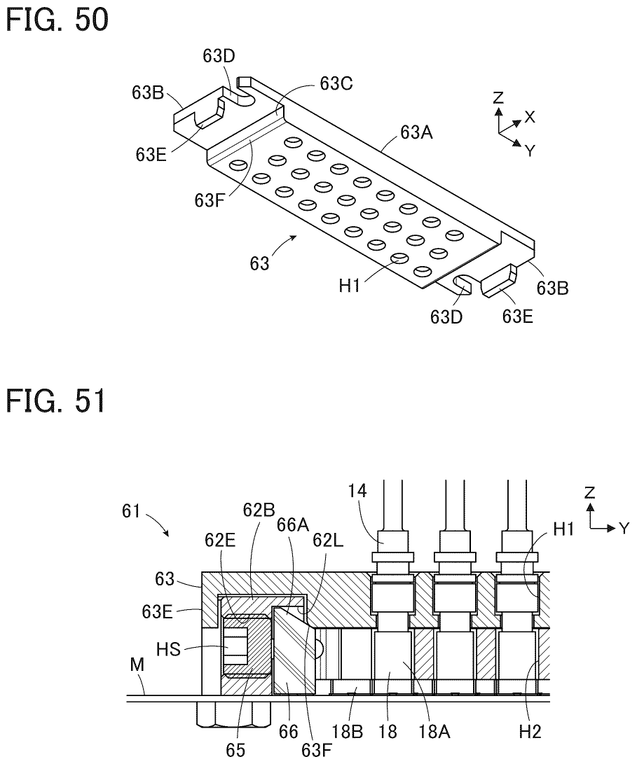

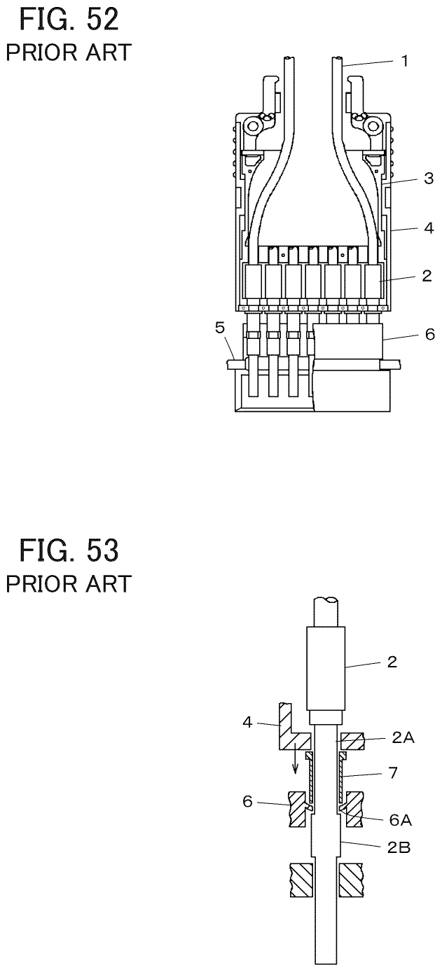

As shown in FIGS. 49 and 50, the cover member 63 is made of an insulating material such as an insulating resin and includes a cover body 63A of flat plate shape that extends in the Y direction along an XY plane and support portions 63B that are separately and integrally joined to the +Y directional end portion and the −Y directional end portion of the cover body 63A. The cover body 63A is provided with the first through holes H1 penetrating the cover body 63A in the Z direction.

A step portion 63C is formed between the surface of the cover body 63A on the −Z direction side and the surface of each support portion 63B on the −Z direction side, and the step portion 63C is provided with a cam member receiving portion 63F that extends in the X direction and is inclined with respect to the Y direction.

Each support portion 63B is provided with a cutout 63D that allows the cover member fixing screw 17 to be inserted therein and then screwed into the fixation hole 62H of the base member 62.

In addition, projections 63E projecting in the −Z direction are formed separately at the +Y directional end portion of the support portion 63B disposed on the +Y direction side and the −Y directional end portion of the support portion 63B disposed on the −Y direction side.

The cover member 63 is configured to be aligned with the base member 62 and stacked on the base member 62 when disposed on the +Z direction side of the base member 62.

Now, a method of assembling the connector assembly 61 is described.

As shown in FIG. 51, the base member 62 is disposed on the mounting surface M while the fitting portions 18A of the second connectors 18 are inserted into the second through holes H2 of the base member 62, and the base member 62 is fixed onto the mounting surface M by use of the base member fixing screws 16 (FIGS. 43 to 46). Further, the cover member 63 is disposed to be stacked on the base member 62, and the cover member 63 is fixed with respect to the base member 62 by use of the cover member fixing screws 17 (FIGS. 43 to 46).

The pair of support portions 62B of the base member 62 is each provided with a guiding path 62L communicating with the screw hole 62E and extending along the Y direction, and a cam member 66 is disposed inside the guiding path 62L to be movable along the Y direction. The cam member 66 is made of, for instance, a thermoplastic resin material such as polyoxymethylene, and the cam member 66 is provided at its +Z directional end portion with a cam surface 66A that is inclined with respect to the Y direction and faces the cam member receiving portion 63F of the cover member 63.

Two cam members 66 are disposed to correspond to the screw holes 62E that are formed separately in the −Y directional end portion and the +Y directional end portion of the base member 62.

In addition, the set screws 65 are screwed and held separately in the screw holes 62E in the base member 62 in advance. The set screw 65 has a central axis extending along the Y direction, and the outer peripheral surface of the set screw 65 is provided with a male thread centered on the central axis over the entire Y-directional length of the set screw 65. On the other hand, the inner peripheral surface of the screw hole 62E is provided with a female thread corresponding to the male thread of the set screw 65.

A +Z directional portion of the screw hole 62E is covered by the projection 63E of the cover member 63 when viewed from the Y direction, and the hexagon socket HS of the set screw 65 screwed and held in the screw hole 62E is exposed in the Y direction between the projection 63E of the cover member 63 and the mounting surface M.

The first connectors 14 are inserted from the +Z direction into the first through holes H1 of the cover member 63 thus fixed to the base member 62, whereby the first connectors 14 are fitted to the second connectors 18 separately, and the assembling operation of the connector assembly 61 is completed.

It should be noted that the base member 62, the cover member 63, the two set screws 65, and the two cam members 66 constitute a removal adapter used to collectively remove the first connectors 14 from the second connectors 18.

In addition, the screw hole 62E of the base member 62, the set screw 65 screwed in the screw hole 62E, the cam member 66, and the cam member receiving portion 63F of the cover member 63 constitute a cover member moving mechanism used to move the cover member 63 away from the base member 62 along the fitting direction. While the cover member moving mechanism is disposed at the −Y directional end of the connector assembly 61 as shown in FIG. 51, the same cover member moving mechanism is also disposed at the +Y directional end of the connector assembly 61.

Further, the projection 63E of the cover member 63 which covers the +Z directional portion of the screw hole 62E when viewed from the Y direction constitutes a fall-off preventing portion that prevents the set screw 65 from falling off the screw hole 62E.

When the first connectors 14 are collectively removed from the second connectors 18 with respect to the connector assembly 61 in the fitting state, first, the two cover member fixing screws 17 are removed to release the fixation state of the cover member 63 with respect to the base member 62. Thereafter, a screw rotating tool (not shown) such as a hexagon wrench is fitted into the hexagon socket HS of the set screw 65, which is exposed in the Y direction between the projection 63E of the cover member 63 and the mounting surface M, to rotate the set screw 65, thereby moving the set screw 65 in the +Y direction with respect to the screw hole 62E of the base member 62.

Since the cam member 66 is disposed inside the guiding path 62L formed to communicate with the screw hole 62E, when the set screw 65 is moved in the +Y direction, the cam member 66 is pushed by the set screw 65 to move in the +Y direction along the guiding path 62L, and the cam member receiving portion 63F of the cover member 63 is pressed in the +Y direction by the cam member 66. Since the cam member 66 has the cam surface 66A inclined with respect to the Y direction, a force toward the +Z direction is exerted on the cover member 63 by the cam member 66, so that the cover member 63 is moved in the +Z direction away from the base member 62.

As a result, the first connectors 14 are removed from the second connectors 18 in the same manner as the connector assembly 41 of Embodiment 4.

Thus, also in Embodiment 6, it is possible to collectively remove the first connectors 14 fitted with the second connectors 18 from the second connectors 18 despite its simple structure.

In addition, the set screw 65 is prevented from falling off the screw hole 62E owing to the fall-off preventing portion constituted of the projection 63E of the cover member 63 which covers the +Z directional portion of the screw hole 62E in the state where the cover member 63 is in contact with the base member 62.

While in the removal adapter in Embodiments 1 to 6 above, use are made of the two set screws 15, 25, 45, 55, 65 or flanged screws 35 disposed separately at the −Y directional end portion and the +Y directional end portion of the connector assembly 11, 21, 31, 41, 51, 61, the invention is not limited thereto, and for example, one set screw or flanged screw, or three or more set screws or flanged screws may be used depending on the number of the first connectors 14 and the second connectors 18.

What is claimed is:

1. A removal adapter for collectively removing a plurality of first connectors fitted, along a fitting direction, with a plurality of second connectors attached to an electronic device, from the plurality of second connectors, the removal adapter comprising:
a base member fixed to the electronic device;
a cover member having a plurality of first through holes in which the plurality of first connectors are inserted, the cover member being disposed to contact the base member in the fitting direction in a fitting state between the plurality of first connectors and the plurality of second connectors;
a cover member moving mechanism having a set screw screwed and held in a screw hole formed in one of the base member and the cover member, the cover member moving mechanism being configured to move the cover member away from the base member along the fitting direction when the set screw is rotated to be moved; and
a fall-off preventing portion configured to prevent the set screw from falling off the screw hole in a state where the cover member is in contact with the base member,
wherein each of the plurality of first through holes has a dimension smaller than a dimension of a widest portion of each of the plurality of first connectors, and
when the cover member is moved using the cover member moving mechanism, the plurality of first connectors are moved together with the cover member in the fitting direction and removed from the plurality of second connectors.

2. The removal adapter according to claim 1,
wherein the base member has a plurality of second through holes corresponding to the plurality of second connectors, and the base member is fixed to the electronic device with the plurality of second connectors being inserted in the plurality of second through holes.

3. The removal adapter according to claim 1,
wherein the cover member moving mechanism includes:
the screw hole formed in the base member along the fitting direction; and
a screw receiving portion formed of a part of the cover member and disposed to cover the screw hole,
the screw receiving portion has a tool through hole that penetrates the screw receiving portion in the fitting direction and that communicates with the screw hole along the fitting direction,
the tool through hole has a diameter smaller than a diameter of the screw hole, and
when a screw rotating tool is inserted in the tool through hole to rotate the set screw screwed and held in the screw hole so that the set screw is moved along the fitting direction, the set screw pushes the screw receiving portion, whereby the cover member is moved away from the base member.

4. The removal adapter according to claim 3,
wherein the fall-off preventing portion is formed of the screw receiving portion.

5. The removal adapter according to claim 3,
wherein the cover member moving mechanism has a flanged screw in place of the set screw.

6. The removal adapter according to claim 5,
wherein the fall-off preventing portion is formed of a flange of the flanged screw.

7. The removal adapter according to claim 1,
wherein the cover member moving mechanism includes:
the screw hole formed in the cover member along the fitting direction and having one end that opens toward the base member; and
a screw receiving portion formed of a part of the base member and disposed to face the screw hole,
the cover member has a tool through hole that penetrates the cover member in the fitting direction and that communicates with the other end of the screw hole along the fitting direction,
the tool through hole has a diameter smaller than a diameter of the screw hole, and
when a screw rotating tool is inserted in the tool through hole to rotate the set screw screwed and held in the screw hole so that the set screw is moved along the fitting direction, the set screw presses the screw receiving portion, and due to a reaction force thereof, the cover member is moved away from the base member.

8. The removal adapter according to claim 7,
wherein the fall-off preventing portion is formed of the cover member around the tool through hole.

9. The removal adapter according to claim 1,
wherein the cover member moving mechanism includes:
the screw hole formed in the base member to extend along an intersecting direction that intersects the fitting direction, from an end portion of the base member in the intersecting direction; and
a screw receiving portion formed of a part of the cover member and having a cam surface inclined with respect to the intersecting direction at a position facing the screw hole, and
when the set screw screwed and held in the screw hole is rotated to move the set screw along the intersecting direction, the set screw pushes the cam surface of the screw receiving portion, whereby the cover member is moved away from the base member.

10. The removal adapter according to claim 9,
wherein the screw receiving portion is disposed at a position facing a second end portion of the screw hole which is situated in an opposite direction from the end portion of the base member.

11. The removal adapter according to claim 10,
wherein the fall-off preventing portion is formed of the cover member disposed to cover a part of the screw hole in a vicinity of the end portion of the base member.

12. The removal adapter according to claim 9,
wherein the screw receiving portion is disposed at a position facing a first end portion of the screw hole which is situated near the end portion of the base member.

13. The removal adapter according to claim 12,
wherein the fall-off preventing portion is formed of the cover member disposed to cover a part of the screw hole in a vicinity of the end portion of the base member.

14. The removal adapter according to claim 1,
wherein the cover member moving mechanism includes:
the screw hole formed in the base member to extend along an intersecting direction that intersects the fitting direction, from an end portion of the base member in the intersecting direction;
a guiding path formed in the base member to communicate with the screw hole and extend along the intersecting direction;
a cam member that is disposed inside the guiding path to be movable along the intersecting direction and that has a cam surface inclined with respect to the intersecting direction; and
a cam member receiving portion formed of a part of the cover member and facing the guiding path, and
when the set screw screwed and held in the screw hole is rotated to move the set screw along the intersecting direction, the cam member is moved along the guiding path, and the cam surface pushes the cam member receiving portion, whereby the cover member is moved away from the base member.

15. The removal adapter according to claim 14,
wherein the fall-off preventing portion is formed of the cover member disposed to cover a part of the screw hole in a vicinity of the end portion of the base member.

16. The removal adapter according to claim 2,
wherein the plurality of first through holes and the plurality of second through holes are aligned along a predetermined alignment direction, and
the cover member moving mechanism is disposed at each of opposite ends in the predetermined alignment direction.

17. A connector assembly comprising:
the plurality of first connectors;
the plurality of second connectors; and
the removal adapter according to claim 1.

18. The connector assembly according to claim 17,
wherein each of the plurality of first connectors has a small diameter portion disposed at a distal end close to a corresponding one of the plurality of second connectors and a large diameter portion disposed on an opposite side from the plurality of second connectors with respect to the small diameter portion and having a diameter larger than a diameter of the small diameter portion,
each of the plurality of first through holes of the cover member is provided, in its inside, with a restricted portion that has a diameter smaller than the diameter of the large diameter portion and larger than the diameter of the small diameter portion of a corresponding one of the plurality of first connectors, and
when the cover member is moved in the fitting direction, the restricted portions of the plurality of first through holes of the cover member catch on the large diameter portions of the plurality of first connectors, so that the plurality of first connectors are moved together with the cover member in the fitting direction.
